(19) United States
(12) Patent Application Publication
(10) Pub. No.: US 2007/0125877 A1
(43) Pub. Date: Jun. 7, 2007

(54) MULTI-COMPONENT LIQUID SPRAY SYSTEMS

(75) Inventors: Daniel J. Zillig, Cottage Grove, MN (US); Subramanian Krishnan, St. Paul, MN (US); William J. Kopecky, Hudson, WI (US); Stanley C. Erickson, Scandia, MN (US); Steven O. Ward, Omaha, NE (US); James C. Breister, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/563,827

(22) Filed: Nov. 28, 2006

Related U.S. Application Data
(60) Provisional application No. 60/748,227, filed on Dec. 1, 2005.

(51) Int. Cl. B05B 1/28

(52) U.S. Cl. 239/290

(57) ABSTRACT

Multi-component liquid spray system including a shim having a first array of first passages and a second array of second passages are described. When the shim is positioned between the first and second die portions of a housing, a first array of first liquid conduits and a second array of second liquid conduits are formed. The first array of first liquid conduits and second array of second liquid conduits are aligned such that at least one of the second liquid conduits is interspersed between successive first liquid conduits. Methods of making such spray systems and methods of using them to produce both multi-component sprays and coated articles are also described.

### CROSS REFERENCE TO RELATED APPLICATION

This application claims the benefit of U.S. Provisional Patent Application No. 60/748,227, filed Dec. 1, 2005, the disclosure of which is incorporated by reference herein in its entirety.

### FIELD

The disclosure relates generally to multi-component liquid spray systems and methods of applying a substantially uniform ratio of a first component and a second component onto a substrate.

### SUMMARY

Briefly, in one aspect, the present disclosure provides a multi-component liquid spray system comprising: a housing comprising a first die portion and a second die portion; and a shim comprising a first array of first passages and a second array of second passages. The shim is positioned between the first and second die portions of the housing forming a first array of first liquid conduits corresponding to the first array of first passages and a second array of second liquid conduits corresponding to the second array of second passages. The first array of first liquid conduits and second array of second liquid conduits are aligned such that at least one of the second liquid passages is interspersed between successive first liquid passages. In some embodiments, each of the first and second passages consists of a slot extending through the thickness of the shim.

In some embodiments, the shim further comprises a third array of air slots forming a third array of air conduits corresponding to the third array of air slots. In some embodiments, each of the first liquid conduits, the second liquid conduits, and the air conduits comprises a feed end located in fluid communication with its corresponding manifold, and a discharge end located proximate an exterior boundary of the housing, wherein the exterior boundary of the housing comprises a first die exit edge and a second die exit edge.

In some embodiments, each of the first passages comprises a first slot portion and a first tunnel portion and each of the second passages comprises a second slot portion and a second tunnel portion. In some embodiments, each of the first and second slot portions extends through the thickness of the shim, and each of the first and second tunnel portions comprises a tunnel circumferentially bounded by the shim. In some embodiments, each of the first tunnel portions comprises a first feed end located proximate a first slot and a first discharge end located proximate an exterior boundary of the housing. In some embodiments, each of the second tunnel portions comprises a second feed end located proximate a second slot and a second discharge end located proximate the exterior boundary of the housing.

In some embodiments, the multi-component liquid spray system further comprises a first air knife comprising an exit slot located proximate the first discharge edge of the first die portion, and a second air knife comprising an exit slot located proximate the second discharge edge of the second die portion.

In another aspect, the present disclosure provides a method of producing a multi-component spray comprising: delivering a first component and a second component to a multi-component liquid spray system; forcing the first component through a first array of first conduits to produce a first spray of the first component; forcing the second component through a second array of second conduits to produce a second spray of the second component; and mixing at least a first portion of the first spray and at least a second portion of second spray.

In yet another aspect, the present disclosure provides a method of making a coated article comprising: delivering a first component and a second component to a multi-component liquid spray system; forcing the first component through a first array of first conduits to produce a first spray of the first component; forcing the second component through a second array of second conduits to produce a second spray of the second component; and impinging the first and second sprays on an article. In some embodiments, at least a portion of the first spray and a portion of the second spray are mixed before impinging on the article.

In another aspect, the present disclosure provides a method of making a multi-component liquid spray system comprising: positioning a shim comprising a first array of first passages and a second array of second passages between a first die portion of a housing and a second die portion of a housing; and coupling the first die portion of the housing to the second die portion of the housing forming a first array of first liquid conduits corresponding to the first array of first passages and a second array of second liquid conduits corresponding to the second array of second passages.

In yet another aspect, the present disclosure provides a multi-component liquid spray system comprising: a housing comprising a first die portion and a second die portion; means for creating a first array of first liquid conduits positioned between the first die portion and the second die portion; means for creating a second array of second liquid conduits positioned between the first die portion and the second die portion; means for delivering a first component in fluid communication with the first array of first liquid conduits; and means for delivering a second component in fluid communication with the second array of second liquid conduits.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1a illustrates an exemplary multi-component liquid spray system of the present disclosure.

FIG. 1b illustrates the first die half of the exemplary multi-component liquid spray system of FIG. 1a.

FIG. 1c is a cross-sectional view of the exemplary multi-component liquid spray system of FIG. 1a.

FIG. 1d is a cross-sectional view of the exit region of the exemplary multi-component liquid spray system of FIG. 1a.

FIG. 2 illustrates a first exemplary shim of the present disclosure.

FIG. 3 illustrates a second exemplary shim of the present disclosure.

FIG. 4 illustrates a third exemplary shim of the present disclosure.

### DETAILED DESCRIPTION

Multi-component liquid spray systems are useful in a variety of applications including the coating of articles or substrates, e.g., wide webs. In some applications, it may be desirable to deliver the multi-component liquid as a spray, i.e., as material moving in a mass of dispersed drops. A variety of factors can limit productivity when delivering multi-component compositions as a spray including, e.g., premature interaction of the components, improper ratios of the components, purging requirements, and non-uniformity of the delivered composition.

In some multi-component liquid spray systems, various components are mixed prior to being delivered from the system. For example, the components may be mixed upstream of a nozzle used to produce a spray. Premature interaction of the components occurs when two or more of the components begin to interact (e.g., react) before exiting the spray system. The interaction of the components can lead to, e.g., a rise in viscosity (e.g., gelling), and/or solidification, which can plug downstream liquid passages, e.g., nozzles and orifices, in the liquid spray system.

When spraying multi-component mixtures, errors in the ratio of the components can occur. If multiple components are mixed in an undesired ratio prior to being discharged from the spray system, the improperly mixed composition must be purged from the spray system. Purging often leads to a substantial waste of resources including time and materials. Purging requirements also make changes in the desired coating composition, e.g., component ratios, inefficient and expensive.

Additional problems may arise when attempting to deliver a uniform ratio of two or more components across the width of a web. Generally, the spray patterns from typical liquid spray systems are not uniform. For example, the amount of material delivered to the web may be higher in the center or at the edges of the spray produced by a single nozzle. Additional non-uniformities arise when the spray pattern produced by a single nozzle is insufficient to cover the entire width of the web. In such situations, the single nozzle may be oscillated or swept across the width of the web leading to additional, undesirable variations in the amount of material delivered per unit area of the web.

If an array of nozzles is used to provide liquid across the width of a web, non-uniform spray patterns from the individual nozzles can lead to defects wherein the amount of liquid delivered to particular regions of the web is significantly greater or less than the average amount of liquid delivered across the width of the web which may result in, e.g., streaks and banding. While these non-uniformities may be acceptable if the multiple components are mixed upstream of the nozzle, such non-uniform sprays may be unacceptable when attempting to achieve a uniform ratio of components by combining the sprays produced by multiple nozzles.

In one aspect, the present disclosure provides multi-component liquid spray systems capable of delivering a plurality of components such that some of the components are not mixed together until after they are discharged from the spray system. In some embodiments, the liquid spray systems of the present disclosure minimize or eliminate the premature interaction of components. In some embodiments, the liquid spray systems of the present disclosure reduce purging requirements. In some embodiments, the liquid spray systems of the present disclosure reduce the time and/or expense required to change the relative concentrations of the various components of a multi-component composition. In another aspect, the present disclosure provides multi-component liquid spray systems capable of delivering a uniform ratio of two or more components across the width of an article, e.g., a web. Other features and advantages of the present disclosure are described below.

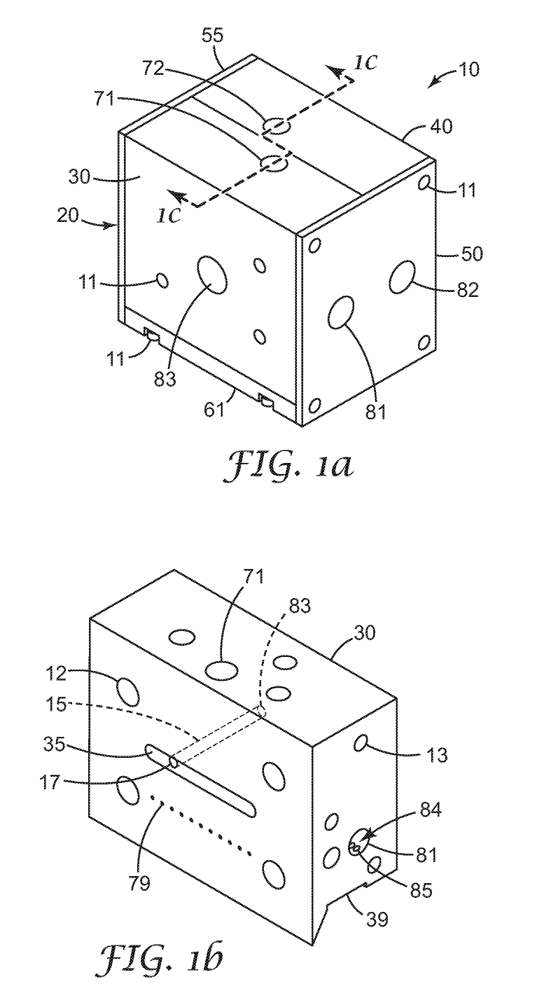

An exemplary multi-component liquid spray system of one embodiment of the present disclosure is shown in FIGS. 1a-1d. Generally, each part of the spray system may be formed from well-known materials such as metals, plastics, and ceramics. Exemplary materials include stainless steel, copper, and nylon. Selection of the material used for each part is within the ordinary skill in the art. Depending on the application, factors affecting selection may include compatibility with the materials being sprayed, ease of manufacture, cost, corrosion and abrasion resistance, thermal conductivity and stability, and durability.

Referring to FIG. 1a, multi-component liquid spray system 10 comprises housing 20. Housing 20 includes first die portion 30, which is attached to second die portion 40 via bolts 11. Side panels 50 and 55 are mounted to the first and second die portions via bolts 11. First air knife 61 is mounted to first die portion 30 via bolts 11. Similarly, a second air knife (not shown) is mounted to the second die portion. Other means of attaching the various parts of the spray system together are possible, e.g., mechanical fasteners, welds, and adhesives.

Multi-component liquid spray system 10 also includes first component inlet port 71, second component inlet port 72, and air inlet ports 81, 82, and 83. Air inlet port 81, shown in side panel 50, along with a similar air inlet port in side panel 55 (not shown), feeds first air knife 61. Air inlet port 82, shown in side panel 50, along with a similar air inlet port in side panel 55, feeds the second air knife (not shown). Air inlet port 83, shown in first die portion 30, feeds the air channels in the spray shim (not shown). Selection of the numbers and locations of the various ports is a matter of routine design considerations and may be affected by, e.g., properties of the materials being delivered (e.g., density and viscosity), desired flow rates and distributions, the dimensions of the spray system, spatial constraints within the housing (e.g., desired liquid and/or air pathways), and spatial constraints outside the housing (e.g., desired locations of feed systems and mounting features).

Referring to FIG. 1b, first die portion 30, rotated approximately 180° from its orientation in FIG. 1a, is shown. First die portion 30 comprises mounting holes 12, which receive bolts connecting the second die portion to the first die portion, and mounting holes 13, which receive bolts connecting a side panel to the first die portion. During operation, air flows from an air source (e.g., a compressed air source) into first die portion 30 through air inlet port 83. In some embodiments, gases or vapors other than air may be used, e.g., oxygen, nitrogen, carbon dioxide, and water vapor. Air passes through air channel 15 and into air chamber 35 via orifice 17.

First die portion 30 also includes a plurality of first component feed orifices 79, which are in fluid communication with first component inlet port 71. In some embodiments, first component feed orifices are linearly aligned, as shown in FIG. 1b. In some embodiments, the first component feed orifices are circular. However, any orifice shape may be used, e.g., geometric shapes (square, triangular, elliptical, or hexagonal), irregular shapes, and slots.

Air inlet port 81 feeds first air knife pressure equalization chamber 84. Channels 85 allow air to pass from the first air knife pressure equalization chamber 84 to a first air knife cavity formed in part by first die recess 39. In some embodiments, other flow geometries may be used to connect the air equalization chamber to the air knife cavity, e.g., slots. In some embodiments, gases or vapors other than air may be used, e.g., oxygen, nitrogen, carbon dioxide, and water vapor.

Generally, second die portion 40 is similar to first die portion 30. In some embodiments, second die portion 40 does not include an air chamber or the associated air inlet port and air channel that would feed such an air chamber.

Referring to FIG. 1c, a cross section of multi-component liquid delivery system 10, taken along line 1C-1C of FIG. 1a, is shown. In operation, a first liquid comprising a first component is fed to first die portion 30 via first component inlet port 71. The first liquid flows through first liquid passage 73 and fills first liquid pressure equalization chamber 75. In some embodiments, a plurality of first liquid pressure equalization chambers may be used, either in parallel, in series, or both. The first liquid flows from first liquid pressure equalization chamber 75 through a plurality of first flow tubes 77, exiting through a plurality of corresponding first component feed orifices 79, adjacent shim 90. Similarly, a second liquid comprising a second component is fed to second die portion 40 via second component inlet port 72. The second liquid flows through second liquid passage 74, filling at least one second liquid pressure equalization chamber 76. The second liquid flows from second liquid equalization chamber 76, through a plurality of second flow tubes (not shown) and exits through a plurality of corresponding second component feed orifices (not shown).

In some embodiments, the design of the component inlet ports, liquid passages, liquid pressure equalization chambers, and component feed orifices are selected to provide a substantially uniform pressure at the entrance to all of the component feed orifices. In some embodiments, the pressure within the first liquid pressure equalization chamber will be substantially the same as the pressure within the second liquid pressure equalization chamber (i.e., within plus or minus 10%). In some embodiments, the pressure within the first liquid pressure equalization chamber will be at least about 10%, in some embodiments, at least about 25%, in some embodiments, at least about 50%, or even at least about 100% greater than the pressure within the second liquid pressure equalization chamber. In some embodiments, the pressure within the first liquid pressure equalization chamber will be less than about 90%, in some embodiments, less than about 75%, in some embodiments, less than about 50%, or even less than about 25% of the pressure within the second liquid pressure equalization chamber.

First air knife cavity 63 comprises the opening between first air knife 61 and first die recess 39. Similarly, second air knife cavity 64 comprises the opening between second air knife 62 and second die recess 49. Air knife pressure equalization chamber 86 is in fluid communication with air knife cavity 64, via channels 87. Similarly, air knife pressure equalization chamber 84 is in fluid communication with air knife cavity 63, via channels (not shown).

Air from first air knife cavity 63, flows through first gap 67 between first die extension 31 and first air knife extension 65. Air exits the first air knife assembly proximate first die exit edge 32. In some embodiments, first air knife extension 65 terminates upstream of first die exit edge 32. Similarly, air from second air knife cavity 64, flows through second gap 68 between second die extension 41 and second air knife extension 66. Air exits the second air knife assembly proximate second die exit edge 42. In some embodiments, second air knife extension 66 terminates upstream of second die exit edge 42.

Air chamber 35 is bounded on one side by shim 90. As shown in FIG. 1b, air chamber 35 is fed by inlet port 83, air channel 15, and orifice 17.

Referring to FIG. 1d, the region of multi-component liquid spray system 10 near the first and second die exit edges is shown. In some embodiments, an air knife is adjustably mounted to a die portion by passing bolts through slots in first air knife and connecting them to threaded mounting holes in the die portion. Thus, width A of first gap 67 can be adjusted by altering the position of first air knife 61 relative to first die portion 30, and width B of second gap 68 can be adjusted by altering the position of second air knife 62 relative to second die portion 40. In some embodiments, the width of first gap 67 can be adjusted independently of the width of second gap 68.

First air knife 61 includes first air knife extension 65, which terminates along first air knife edge 60. As shown in FIG. 1d, first air knife edge 60 is recessed relative to first die exit edge 32 of first die extension 31. In some embodiments, the amount of recess can be adjusted by positioning one or more shims between first die portion 30 and first air knife 61. Similarly, one or more shims may be positioned between second die portion 40 and second air knife 62, thereby adjusting the recess of second air knife edge 69 of second air knife extension 66 relative to second die exit edge 42 of second die extension 41. In some embodiments, the first recess can be adjusted independently of the second recess.

As shown in FIG. 1d, in some embodiments, first die exit edge 32 and second die exit edge 42 are in the same plane. In some embodiments, the first die exit edge may be recessed relative to the second die exit edge. In some embodiments, the second die exit edge may be recessed relative to the first die exit edge.

In some embodiments, discharge edge 91 of shim 90 lies in the same plane as first die exit edge 32 and second die exit edge 42. In some embodiments, discharge edge 91 may be recessed or advanced relative to one or both of the die exit edges.

Generally, the shim may be manufactured from well-known materials such as metals and plastics. In some embodiments, it may be desirable to use a material that is more compressible than the materials used to form the first and second die portions. Exemplary shim materials include stainless steel, copper, polyester, and nylon.

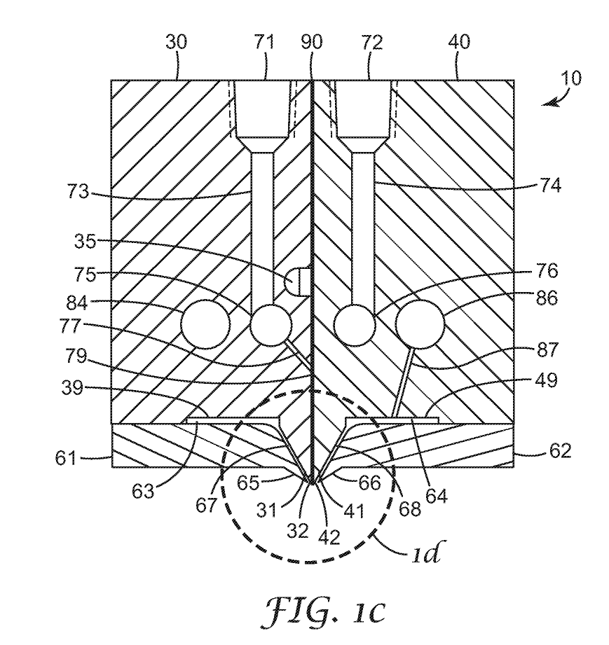

Referring to FIG. 2, shim 190 of one embodiment of the present disclosure is shown. Shim 190 includes mounting holes 110 through which pass the bolts attaching the first die portion to the second die portion. Shim 190 also includes a plurality of each of three different passages, which extend through the thickness of the shim.

First liquid slots 130 extend from first liquid inlets 131 to discharge edge 199. First liquid inlets 131 are positioned to align with the first component feed orifices in the first die portion. Similarly, second liquid slots 140 extend from second liquid inlets 141 to discharge edge 199. Second liquid inlets 141 are positioned to align with the second component feed orifices in the second die portion. In some embodiments, first liquid slots 130 and second liquid slots 140 are linearly aligned along the shim such that at least one second liquid slot is located between successive first liquid slots. In some embodiments, first liquid slots 130 and second liquid slots 140 are aligned in alternating positions.

Optional air slots 120 extend from air slot inlets 121 to discharge edge 199 of shim 190. Air slot inlets 121 are positioned to align with air chamber 35 in the first die portion (see, e.g., FIG. 1c). In operation, air flows from the air chamber, along the conduits defined by air slots 120 and the first and second die portions. In some embodiments, at least one air slot 120 is positioned between consecutive first and second liquid slots.

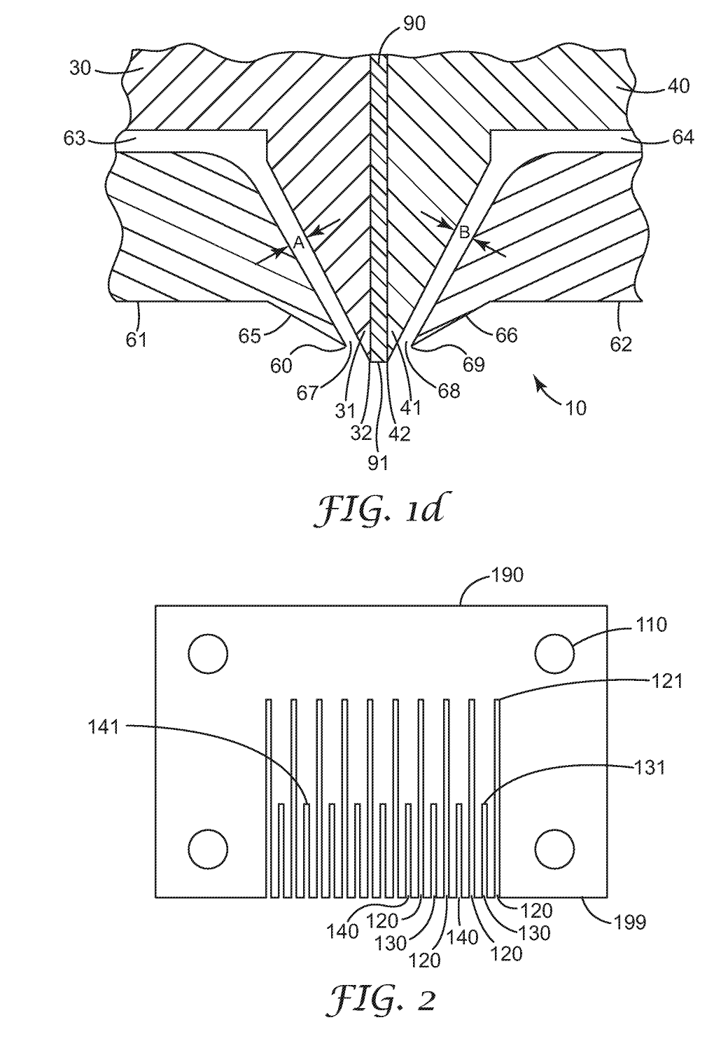

Shim 290 of another embodiment of the present disclosure is shown in FIG. 3. Shim 290 includes mounting holes 210, optional air slots 220, first liquid slots 230, and second liquid slots 240. Discharge edge 199 of shim 190 (shown in FIG. 2) is a linear discharge edge. In contrast, the discharge edge of shim 290 comprises a saw-tooth profile comprising alternating peaks and valleys. This saw-tooth profile arises when discharge ends 222 of air slots 220 are beveled, directing air toward first liquid slot discharge end 232 and second liquid slot discharge end 242.

As shown in FIG. 3, substantially all of the first and second liquid slots terminate proximate peaks of the saw-tooth profile, while substantially all of the air slots terminate proximate valleys of the saw-tooth profile. In some embodiments, the angle at which the discharge end of an air slot is beveled relative to its primary axis (i.e., the bevel angle) is at least 10°, in some embodiments, at least 15°, at least 20°, or even at least 30°. In some embodiments, the bevel is less than 75°, in some embodiments, less than 60°, less than 50°, or even less than 45°. In some embodiments, the bevel angle is between 15° and 60°, inclusive, and in some embodiments, between 20 and 40°, inclusive.

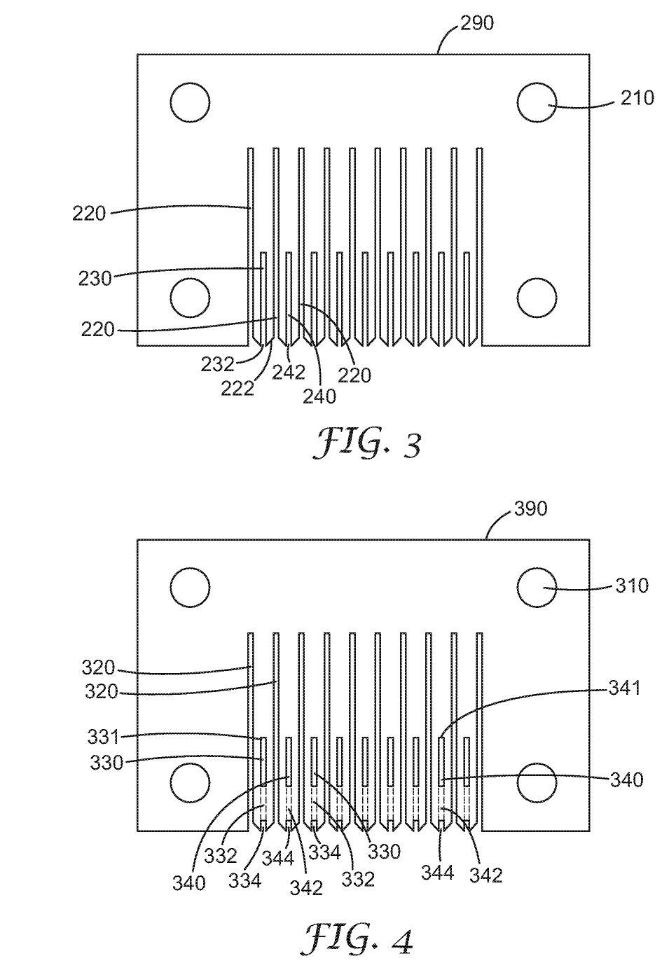

Shim 390 of yet another embodiment of the present disclosure is shown in FIG. 4. Shim 390 includes mounting holes 310, and optional air slots 320, which extend through the thickness of shim 390. In some embodiments, the discharge end of shim 390 comprises a saw-tooth profile. This saw-tooth profile arises when the discharge end of air slots 320 are beveled directing air toward first orifices 334 and second orifices 344.

In some embodiments, the angle at which the discharge end of an air slot is beveled relative to its primary axis (i.e., the bevel angle) is at least 10°, in some embodiments, at least 15°, at least 20°, or even at least 30°. In some embodiments, the bevel is less than 75°, in some embodiments, less than 60°, less than 50°, or even less than 45°. In some embodiments, the bevel angle is between 15° and 60°, inclusive, and in some embodiments, between 20 and 40°, inclusive.

Shim 390 also includes a first array of first passages and a second array of second passages. Each of the first passages comprises a first liquid slot and a first liquid tunnel. First liquid slots 330, which begin at first liquid inlets 331 and terminate at first liquid tunnels 332, extend through the thickness of shim 390. First liquid tunnels 332 are circumferentially bounded by shim 390. Similarly, second liquid slots 340 extend through the thickness of shim 390, while second liquid tunnels 342 are circumferentially bounded by shim 390. Second liquid slots 340 begin at second liquid inlets 341 and terminate at second liquid tunnels 342.

The locations of the first liquid inlets are selected to align with the first component feed orifices in the first die portion. In operation, the first liquid, comprising the first component, flows through the first component feed orifices, along first liquid slots 330, and into first liquid tunnels 332. The first liquid is then sprayed out of first orifices 334.

The locations of the second liquid inlets are selected to align with the second component feed orifices in the second die portion. In operation, the second liquid, comprising the second component, flows through the second component feed orifices, along second liquid slots 340, and into second liquid tunnels 342. The second liquid is then sprayed out of second orifices 344.

Generally, the multi-component liquid spray dies of the present disclosure may be used in any application where it is desirable to mix two or more components downstream of the spray system discharge. In some embodiments, a first component and a second component are mixed downstream of the spray system discharge. In some embodiments, a first liquid comprising a first component is atomized producing a first spray comprising a mass of dispersed drops of the first liquid. Similarly, in some embodiments, a second liquid comprising a second component is atomized producing a second spray comprising a mass of dispersed drops of the second liquid. In some embodiments, at least a portion of the drops of the first spray mix with a portion of the drops of the second spray in flight from the spray system discharge to a substrate. In some embodiments, the first and second components interact, e.g., react, while the drops are in flight.

Generally, the first and second sprays impinge on the substrate forming a layer comprising the first and second liquids, which may include the reaction product of the first and second components. In some embodiments, at least a portion of the first and second liquids do not mix until the liquids reach the substrate.

In some embodiments, the flow rates of the first and second liquids can be adjusted independently. In some embodiments, it may be desirable to control the ratio of a first component to a second component. Generally, the target ratio depends on the specific end use application and could be any value. For example, in some embodiments, the first and second components may react with one another, and the target ratio may be one. In some embodiments, a slight excess of first component to the second component may be desired, and the target ratio may be higher than one, e.g., 1.01, 1.1, 1.5, etc. In some embodiments, one component may be a catalyst and the desired amount of that component may be small relative to a second component leading to a target ratio of 0.5 or even less, e.g., 0.1, 0.05, or even 0.01.

In some embodiments, the first and second component may be non-reactive, e.g., dyes and other colorants. In some embodiments, it may be desirable to vary the ratios of the first and second components to vary the resulting color of the mixture of dyes or other colorants. For example, if the first component were a blue dye and the second component were a yellow dye, various shades of green could be obtained by varying the ratio of the first component (i.e., the blue dye) relative to the second component (i.e., the yellow dye).

Generally, the multi-component spray systems of some embodiments of the present disclosure can be used to produce a uniform ratio of the first and second components across the entire length of the spray system. In some embodiments, the ratio of the first component to the second component is within 10% of the target ratio across the length of the spray system, in some embodiments, within 5%, in some embodiments, within 2%, and in some embodiments, within 1%, or even less, of the target ratio across the length of the spray system.

In some embodiments, spray systems of the present invention can be mounted in a stationary position relative to a web or article. As the web or article moves past the spray system, the components will be applied in a substantially uniform ratio across a desired width of the web or article, up to and including the entire width of the web or article. In some embodiments, a single stationary spray system of the present invention can be used to apply a uniform ratio of components across a width of greater than 5 centimeters (cm), in some embodiments, greater than 25 cm, and in some embodiments, greater than 60 cm. In some embodiments, a single stationary spray system of the present invention may be used to apply a uniform ratio of components to wide webs or articles, i.e., webs or article having widths greater than 90 cm, greater than 150 cm, or even greater than 300 cm.

The following specific, but non-limiting, example will serve to illustrate one embodiment of the disclosure.

A spray system as shown in FIGS. 1a-d and a shim as shown in FIG. 3 were used to mix and apply a blend of VERSALINK P-1000 oligomeric diamine (Air Products and Chemicals Inc., Allentown, Pa.) and ISONATE 143L Diphenylmethane Diisocyanate (Dow Chemical USA, Midland, Mich.) at a 4.00:1.00 weight ratio. The shim had a slot row width of 5.08 cm (2 inches).

The VERSALINK P-1000 was heated to 100° C. (212° F.) in a heated hopper that fed a 1.168 cubic centimeter/revolution metering gear pump (Parker Hannefin Corporation, Zenith Division, Sanford, N.C.). This gear pump was operated at 34 revolutions/minute, which produced a back-pressure of about 2060.8 KPa (300 lbs./square inch). A neck tube having a 6.35 mm (0.25 inch) outside diameter (O.D.) and a 0.89 mm (0.035 inch) wall thickness was used to connect the gear pump to the inlet of one side of the die.

The ISONATE 143L was not heated. It was fed to the other side of the die using a 1.20 cubic centimeter/revolution metering gear pump (Parker Hannefin Corporation, Zenith Division, Sanford, N.C.) that was operated at 6.8 revolutions per minute. This gear pump and die were connected using a 6.35 mm O.D.×0.89 mm wall thickness (0.25 inch O.D.×0.035 inch wall thickness) neck tube.

The slotted shim that forms the orifices of the die had a thickness of 0.25 mm (0.010 inch). The slot widths for the VERSALINK P-1000 were 0.20 mm (0.008 inch) wide while the slot widths for both the ISONATE 143L and atomizing air were 0.13 mm (0.005 inch) wide. The atomizing air slots were centered between each VERSALINK P-1000 and ISONATE 143L slot. The repeat frequency of the VERSALINK P-1000 and ISONATE 143L slots was 5.08 mm (0.200 inch) while the repeat frequency of the air slots was 2.54 mm (0.100 inch).

Compressed air was heated to 121° C. (250° F.) and fed to the four air distribution manifold inlets at 124 KPa (18 psi). This heated compressed air flowed in 0.38 mm gaps (0.015 inch) that were created between the tip of the die and the air knives. Non-heated, compressed air was also supplied to the air slots in the shim. As the two components exited the ends of the slots, the compressed air caused them to atomize, mix, and be blown onto a web that was passing under the die at a distance of about 63.5 mm (2.5 inches). Upon visual inspection, the web was uniformly coated and the input materials were well mixed. The composition, when cured, formed a tough, rubbery coating on the web.

Various modifications and alterations of this invention will become apparent to those skilled in the art without departing from the scope and spirit of this invention.

What is claimed is:

1. A multi-component liquid spray system comprising:
a housing comprising a first die portion and a second die portion; and
a shim comprising
a first array of first liquid passages; and
a second array of second liquid passages, wherein at least one of the second liquid passages is located between successive first liquid passages;
wherein the shim is positioned between the first and second die portions of the housing forming a first array of first liquid conduits corresponding to the first array of first liquid passages, and a second array of second liquid conduits corresponding to the second array of second liquid passages.

2. The multi-component liquid spray system of claim 1, wherein each of the first liquid passages and each of the second liquid passages consists of a slot extending through the thickness of the shim.

3. The multi-component liquid spray system of claim 1, wherein the shim further comprises a third array of air slots extending through the thickness of the shim; wherein the shim is positioned between the first and second portions of the housing forming a third array of air conduits corresponding to the third array of air slots, and wherein at least one air slot is interspersed between adjacent first and second passages.

4. The multi-component liquid spray system of claim 3, wherein
each of the first liquid conduits comprises a feed end in fluid communication with a first liquid manifold and a discharge end located proximate an exterior boundary of the housing;
each of the second liquid conduits comprises a feed end in fluid communication with a second liquid manifold and a discharge end located proximate an exterior boundary of the housing; and
each of the air conduits comprises a feed end in fluid communication with an air manifold and a discharge end located proximate an exterior boundary of the housing; wherein the exterior boundary of the housing comprises a first die exit edge and a second die exit edge.

5. The multi-component liquid spray system of claim 4, further comprising a first air knife comprising an exit slot located proximate the first die exit edge, and a second air knife comprising an exit slot located proximate the second die exit edge.

6. The multi-component liquid spray system of claim 4, wherein the shim further comprises a terminal edge located proximate the exterior boundary of the housing, wherein the terminal edge is substantially parallel to the first die exit edge.

7. The multi-component liquid spray system of claim 4, wherein the shim further comprises a terminal edge located proximate the exterior boundary of the housing, wherein the terminal edge comprises a saw-tooth profile comprising alternating peaks and valleys.

8. The multi-component liquid spray system of claim 7, wherein substantially all of the first and second liquid passages terminate proximate peaks of the saw-tooth profile, and wherein substantially all of the air slots terminate proximate valleys of the saw-tooth profile.

9. The multi-component liquid spray system of claim 1, wherein each of the first liquid passages comprises a first slot portion extending through the thickness of the shim, and a first tunnel portion circumferentially bounded by the shim; and wherein each of the second liquid passages comprises a second slot portion extending through the thickness of the shim, and a second tunnel portion circumferentially bounded by the shim.

10. The multi-component liquid spray system of claim 9, further comprising a first manifold in fluid communication with a plurality of the first slot portions of the first liquid passages, and a second manifold in fluid communication with a plurality of the second slot portions of the second liquid passages.

11. The multi-component liquid spray system of claim 9, wherein each of the first tunnel portions comprises a first feed end located proximate a first slot and a first discharge end located proximate an exterior boundary of the housing, and wherein each of the second tunnel portions comprises a second feed end located proximate a second slot and a second discharge end located proximate the exterior boundary of the housing; wherein the exterior boundary of the housing comprises a first die exit edge and a second die exit edge.

12. The multi-component liquid spray system of claim 11, further comprising a first air knife comprising an exit slot located proximate the first die exit edge, and a second air knife comprising an exit slot located proximate the second die exit edge.

13. The multi-component liquid spray system of claim 11, wherein the shim further comprises a third array of third slots; wherein the shim is positioned between the first and second portions of the housing forming a third array of air conduits corresponding to the third array of third slots, and wherein at least one air conduit is interspersed between adjacent first and second liquid conduits.

14. The multi-component liquid spray system of claim 13, wherein each of the third slots comprise a third feed end in fluid communication with an air manifold, and a third discharge end located proximate an exterior boundary of the housing.

15. The multi-component liquid spray system of claim 14, wherein the third discharge ends of the third slots are recessed relative to the first discharge ends of the first tunnel portions of the first liquid slots.

16. The multi-component liquid spray system of claim 15, wherein the third discharge ends of the third slots have a bevel angle of between 15° and 60°, inclusive.

17. A method of producing a multi-component spray comprising:
delivering a first component and a second component to the multi-component liquid spray system of claim 1;
forcing the first component through the first array of first conduits to produce a first spray of the first component;
forcing the second component through the second array of first conduits to produce a second spray of the second component; and
mixing at least a first portion of the first spray and at least a second portion of second spray.

18. A method of making a coated article comprising:
delivering a first component and a second component to the multi-component liquid spray system of claim 1;
forcing the first component through the first array of first conduits to produce a first spray of the first component;
forcing the second component through the second array of first conduits to produce a second spray of the second component; and
impinging the first and second sprays on an article; wherein at least a portion of the first spray and the second spray are mixed before impinging on the article.

19. A method of making a multi-component liquid spray system comprising:
positioning a shim comprising a first array of first liquid passages and a second array of second liquid passages between a first die portion of a housing and a second die portion of the housing; and
coupling the first die portion of the housing to the second die portion of the housing forming a first array of first liquid conduits corresponding to the first array of first liquid passages; and a second array of second liquid conduits corresponding to the second array of second liquid passages.

20. A multi-component liquid spray system comprising:
a housing comprising a first die portion coupled to a second die portion;
means for creating a first array of first liquid conduits positioned between the first portion and the second portion;
means for creating a second array of second liquid conduits positioned between the first portion and the second portion;
means for delivering a first component in fluid communication with the first array of first liquid conduits; and
means for delivering a second component in fluid communication with the second array of second liquid conduits.
